(19) United States
(12) Patent Application Publication
(10) Pub. No.: US 2006/0291800 A1
(43) Pub. Date: Dec. 28, 2006

(54) Information processing apparatus and picture recording control method

(75) Inventor: Keiichi Uehara, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/454,285

(22) Filed: Jun. 15, 2006

(30) Foreign Application Priority Data
Jun. 23, 2005 (JP) 2005-183515

(51) Int. Cl. H04N 5/91

(52) U.S. Cl. 386/83

(57) ABSTRACT

According to one embodiment, an information processing apparatus which executes first and second application programs each including a function of recording broadcast program data on the basis of recording reservations, includes a receiver which receives broadcast program data in response to a request to receive broadcast program data from one of the first and second application programs, and a recording management unit which integrates first recording reservation information indicating the contents of recording reservations and created by the first application program and second recording reservation information indicating the contents of recording reservations and created by the second application program, manages the integrated broadcast reservation information containing the first and second recording reservation information, and displays on a display unit a recording reservation table indicating a list of recording reservations contained in the integrated recording reservation information.

### CROSS-REFERENCE TO RELATED APPLICATIONS

This application is based upon and claims the benefit of priority from Japanese Patent Application No. 2005-183515, filed Jun. 23, 2005, the entire contents of which are incorporated herein by reference.

### BACKGROUND

1. Field

One embodiment of the invention relates to an information processing apparatus which has a function of recording broadcast program data in accordance with recording reservations and a picture recording control method for use therewith.

2. Description of the Related Art

In recent years, personal computers have been developed which have the same audio/video (AV) function as AV equipment such as DVD (Digital Versatile Disc) players and TV sets.

Such personal computers are capable of recording broadcast program data, such as TV programs, in addition to watching and recording of the program data.

Japanese Unexamined Patent Publication No. 2002-152645 discloses a computer adapted to make picture recording in accordance with recording reservations. This computer has a power saving feature. In the power saving mode, the computer is switched off upon termination of setting of recording reservations and switched on at a time when the recording start time specified by a recording reservation is drawing on.

In the computer, the process of watching and recording broadcast program data is executed by a TV application program installed in it. Therefore, the function and performance associated with watching and recording will depend greatly on the TV application program installed in the computer. It is thus expected that two or more TV application programs of different types will be used together in coming computers.

In computers, the function of setting recording reservations is generally provided by a TV application program. In addition, the management of recording reservation information indicating the contents of recording reservations is carried out by the TV application program. In computers installed with two or more TV application programs, therefore, recording reservation information will be managed individually by each TV application program. In this case, there is the possibility that a recording reservation set by the user using one TV application program and a recording reservation set by the user using another program may overlap in time. In the event of such overlap, there arises the possibility that broadcast program data specified by the recording reservations overlapping in time may not be recorded normally.

Accordingly, with the computers installed with two or more TV application programs it is required to implement a new function to make effective use of the TV application programs without causing malfunctions associated with recording. In addition, it is required to implement a new power saving function suitable for the computers installed with two or more TV application programs.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of an information processing apparatus according to an embodiment of the present invention;

FIG. 2 is an exemplary block diagram illustrating an example of a system configuration of the information processing apparatus of FIG. 1;

FIG. 3 shows the functional configuration of the BIOS executed by the information processing apparatus of FIG. 1;

FIG. 4 is an exemplary diagram for use in explanation of a first example of a recording reservation table display process carried out by the information processing apparatus of FIG. 1;

FIG. 5 shows an example of a recording reservation table displayed on the display screen of the information processing apparatus of FIG. 1;

FIG. 6 is an exemplary flowchart illustrating the overlap check process carried out by the information processing apparatus of FIG. 1;

FIG. 7 is an exemplary diagram for use in explanation of a second example of a recording reservation table display process carried out by the information processing apparatus of FIG. 1;

FIG. 8 shows the process of displaying a recording reservation table by each application program executed by the information processing apparatus of FIG. 1;

FIG. 9 is an exemplary diagram for use in explanation of the configuration of the application interface section used in the information processing apparatus of FIG. 1;

FIG. 10 is an exemplary diagram for use in explanation of the operation of the power-off control section used in the information processing apparatus of FIG. 1;

FIG. 11 is an exemplary diagram for use in explanation of the operation of the boot control section used in the information processing apparatus of FIG. 1;

FIG. 12 is an exemplary flowchart illustrating a first example of a recording control operation carried out by the information processing apparatus of FIG. 1;

FIG. 13 is an exemplary flowchart illustrating a second example of a recording control operation carried out by the information processing apparatus of FIG. 1;

FIG. 14 is an exemplary diagram for use in explanation of recording reservation information stored in a storage area of the hard disk drive in the information processing apparatus of FIG. 1; and

FIG. 15 is an exemplary timing diagram illustrating an example of a power-saving operation carried out by the information processing apparatus of FIG. 1.

### DETAILED DESCRIPTION

Various embodiments according to the invention will be described hereinafter with reference to the accompanying drawings. In general, according to one embodiment of the invention, an information processing apparatus which executes first and second application programs each including a function of recording broadcast program data on the basis of recording reservations, comprises a receiver which receives broadcast program data in response to a request to receive broadcast program data from one of the first and second application programs, and a recording management unit which integrates first recording reservation information indicating the contents of recording reservations and created by the first application program and second recording reservation information indicating the contents of recording reservations and created by the second application program, manages the integrated broadcast reservation information containing the first and second recording reservation information, and displays on a display unit a recording reservation table indicating a list of recording reservations contained in the integrated recording reservation information.

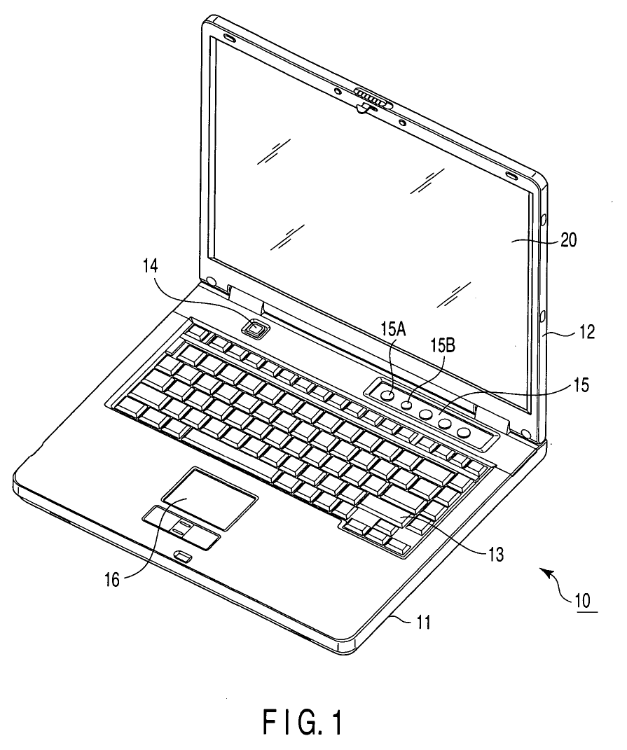

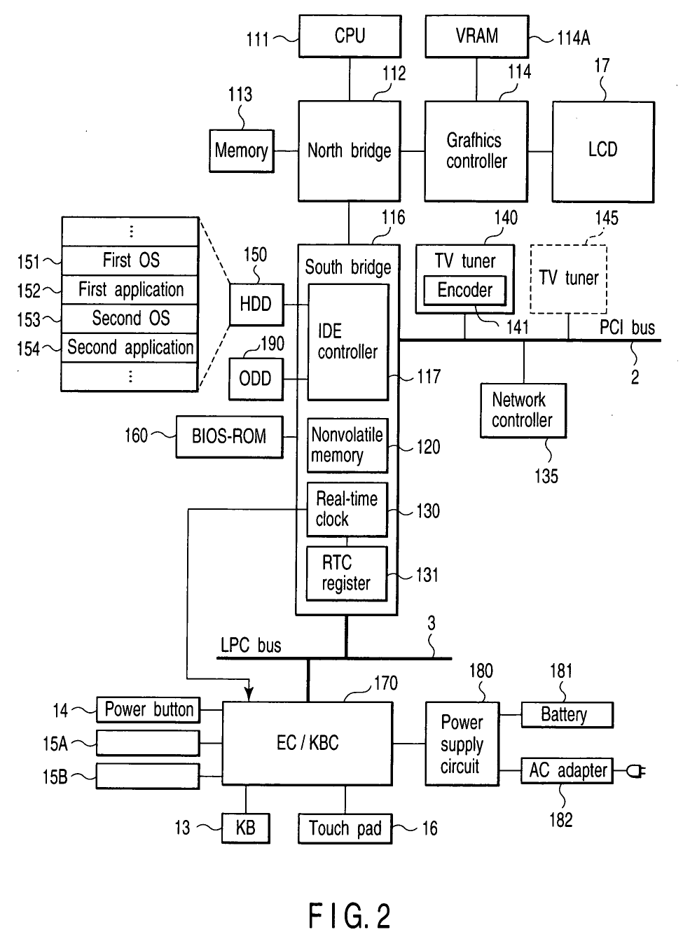

Reference is first made to FIGS. 1 and 2 to describe the configuration of an information processing apparatus according to an embodiment of the present invention. This information processing apparatus is implemented in the form of a battery-driven portable notebook personal computer 10 by way of example. The computer 10 has a function of receiving broadcast program data, such as TV broadcast programs, and reproducing and recording the received broadcast program data. In addition, the computer also has a function of recording broadcast program data in accordance with recording reservations made in advance.

FIG. 1 is a perspective view of the notebook computer 10 with its display unit 12 opened. The computer 10 is formed from a computer body 11 and a display unit 12. The display unit 12 has a display device consisting of an LCD (Liquid Crystal Display) 17 built in. The display screen of the LCD 17 is positioned almost at the center of the display unit 12.

The display unit 12 is rotatably mounted to the computer body 11. The computer body 11 has a thin box-like housing. On the top of the housing are arranged a keyboard 13, a power switch 14 to turn on or off the power to the computer 10, an input operation panel 15, a touch pad 16, and so on. The input operation panel 15 is an input device adapted to input an event corresponding to a depressed button and equipped with two or more buttons each adapted to activate a different function. The buttons include a TV start button 15A and a recording reservation display button 15B.

The computer 10 has been installed with a general-purpose main operating system (hereinafter referred to as a first operating system) and a sub-operating system (hereinafter referred to as a second operating system) which is software dedicated to the TV function (reproducing and recording of broadcast program data).

Depressing the power switch 14 by the user boots up the first operating system. After the first operating system has been booted up, the user is allowed to launch an application program (hereinafter referred to as a first application program) for performing the TV function. The first application program is made to launch on the first operating system.

When the TV start button 15A is depressed by the user, on the other hand, the power is applied to the computer 10, booting the second operating system as opposed to the first operating system. Then, an application program for performing the TV function (hereinafter referred to as a second application program) is launch automatically. The second application program is made to launch on the second operating system.

The second operating system has only the minimum functions for performing the TV function. For this reason, the time required for boot up of the second operating system is much shorter than that for the first operating system. Thus, by simply depressing the TV start button 15A, the user is allowed to instantly utilize the TV function provided by the second application program.

When the recording reservation display button 15B is pressed by the user, the computer 10 is switched on and a list of recording reservations is played on the LCD 17 by a BIOS (Basic Input/Output System). In this list, the contents of recording reservations set by the user operating the first application program and the contents of recording reservations set by the user operating the second application program are displayed collectively.

Next, the system configuration of the computer 10 will be described with reference to FIG. 2.

The computer 10 is equipped, as shown in FIG. 2, with a CPU 111, a north bridge 112, a main memory 113, a graphics controller 114, a south bridge 116, a network controller 135, a TV tuner 140, a hard disk drive (HDD) 150, a BIOS-ROM 160, an embedded controller/keyboard controller IC (EC/KBC) 170, a power supply circuit 180, and an optical disk drive (ODD) 190.

The CPU 111, which is a processor provided to control the operation of the computer 10, executes the first operating system (OS) 151, the first application program 152, the second operating system (OS) 153, and the second application program 154 which are loaded from the hard disk drive 150 into the main memory 113.

Also, the CPU 111 executes the BIOS stored in the BIOS-ROM 160. The BIOS, which is a program to control hardware, has a function of integrating recording reservation information created by the first application program 152 and recording reservation information created by the second application program 154 and managing the integrated recording reservation information.

The north bridge 112, which is a bridge device that connects the CPU 111 and the south bridge 116 together, has a function of making communications with the graphics controller 114 via an AGP (Accelerated Graphics Port) bus.

The graphics controller 114, which is a display controller that controls the LCD 17 used as the display monitor of the computer 10, has a video memory (VRAM) 114A and produces a display signal to be sent to the LCD 17 from video data written into the video memory 114A by the OS/application programs.

The south bridge 116 controls devices on a PCI (Peripheral Component Interconnect) bus 2 and an LPC (Low Pin Count) bus 3. The PCI bus 2 has the TV tuner 140, the network controller 135 and so on connected to it. The LPC bus 3 has the embedded controller/keyboard controller IC 170 connected to it. The south bridge 116 is equipped with an IDE (Integrated Drive Electronics) controller 117, a nonvolatile memory 120, and a real-time clock 130. The IDE controller 117 controls the HDD 150 and the ODD 190. The nonvolatile memory 120 stores recording reservation information. The real-time clock 130 functions as a time-keeping module that measures the current date and time (year, month, day, hours, minutes, seconds). To the real-time clock 130 is connected an RTC (Real-Time Clock) register 131 in which an alarm time is set which specifies a time (year, month, day, hours, minutes, seconds) to switch on the computer 10. When the alarm time set in the RTC register 131 is reached, the real-time clock 130 informs the EC/KBC 170 of the occurrence of a power-on event indicating that the computer 10 is to be switched on.

The TV tuner 140 is a receiving device that receives broadcast program data such as TV broadcast programs. Upon receipt of a request to receive broadcast program data from the first or second application program, the TV tuner 140 receives broadcast program data on the channel specified by that request. The TV tuner 140 is equipped with an encoder 141 that encodes the received broadcast data with compression. The broadcast program data received by the TV tuner 140 is encoded with compression by the encoder 141 and then output on the PCI bus 2.

In addition to the TV tuner 140, the computer 10 may have a TV tuner 145 built in, which has the same function as the TV tuner 140. The use of the two TV tuners 140 and 145 will allow two broadcast programs to be recorded at the same time.

The embedded controller/keyboard controller (EC/KBC) IC 170 is a one-chip microcomputer into which an embedded controller for power control and a keyboard controller for controlling the keyboard 13 and the touch pad 16. The EC/KBC 170 turns on the power to the computer 10 in corporation with the power supply circuit 180 when the power switch 14, the TV start button 15A or the recording reservation display button 15B is depressed by the user while the computer is being switched off. The power supply circuit 180 powers each component of the computer 10 using a battery 181 or an AC adapter 182.

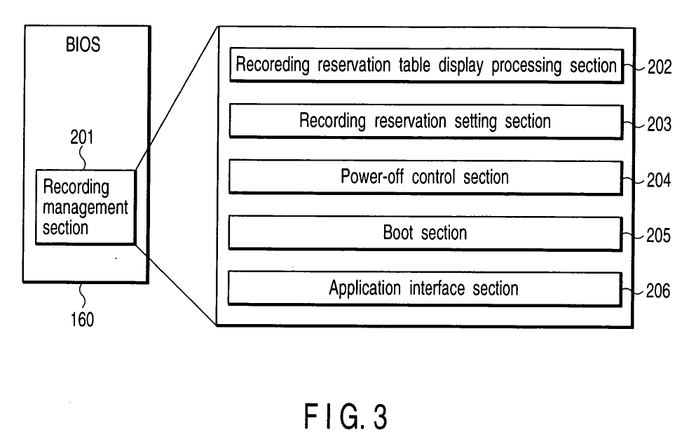

Reference is next made to FIG. 3 to describe the function of the BIOS.

The BIOS has, as one of its functional modules, a recording management section 201 for controlling the recording operation of the computer 10. This section 201 integrates first recording reservation information indicating the contents of recording reservations created by the first application program 152 as operated by the user and second recording reservation information likewise created by the second application program 154 and manages the integrated information containing the first and second recording reservation information. The integrated recording reservation information is stored into the nonvolatile memory 120. The integrated recording reservation information contains an identifier that specifies one of the first and second application programs 152 and 154 for each recording reservation. Each recording reservation created by the first application program 152 is given the identifier indicating the first application program 152. Each recording reservation created by the second application program 154 is given the identifier indicating the second application program 154.

The recording management section 201 includes a recording reservation table display processing section 202, a recording reservation setting section 203, a power-off control section 204, a boot control section 205, and an application interface section 206.

The recording reservation table display processing section 202 allows a recording reservation table indicating a list of recording reservations contained in the integrated recording reservation information to appear on the LCD 17. The recording reservation setting section 203 has a function of adding new recording reservations to the integrated recording reservation information stored in the nonvolatile memory 120 and a function of changing the contents of arbitrary recording reservations in the integrated recording reservation information (including deletion of recording reservations) according to user's operations on the recording reservation table screen of the LCD 17. At the time of adding new recording reservations, the recording reservation setting section 203 allows the user to select one of the first and second application programs to make recording for the new recording reservations. When the first application program is selected by the user, the identifier indicating the first program is given to the new recording reservations. When the second application program is selected, the identifier indicating the second program is given to the new recording reservations.

The power-off control section 204 carries out a process of turning off the power to the computer 10 in response to termination of the recording made by one of the first and second application programs. Specifically, the power-off control section 204 carries out a power control process involving obtaining the immediate recording reservation specifying the recording start time nearest to the current time provided by the real-time clock 130 from the group of the recording reservations contained in the integrated recording reservation information, then setting an alarm time to switch on the computer next time in the RTC register 131 in the real-time clock 130 on the basis of the recording start time specified by the obtained immediate recording reservation and turning off the power to the computer 10.

Further, the power-off control section 204 has a function of deciding whether or not the remaining time from the current time provided by the real-time clock 130 to the recording start time of the immediate recording reservation is shorter than a predetermined time (e.g., five minutes). If the remaining time is not less than the predetermined time, the power-off control section 204 sets the alarm time to switch on the computer next time in the RTC register 131 in the real-time clock 130 in accordance with the recording start time specified by the immediate recording reservation and then turns off the power to the computer 10. The alarm time is set to a time several minutes ahead of the recording start time specified by the immediate recording reservation. If, on the other hand, the remaining time is less than the predetermined time, the power-off control section keeps the computer 10 in the power-on state without performing the power-off process.

The boot control section 205 performs a starting process of changing the computer 10 from the power-off state to the power-on state and booting up one of the first and second application programs in accordance with the recording start time and the identifier for each recording reservation contained in the integrated recording reservation information. Specifically, the boot control section 205 boots up one of the first and second application programs 152 and 154 on the basis of the identifier corresponding to the immediate recording reservation in the integrated recording reservation information when the computer 10 is switched on according to the set alarm time.

The application interface section 206 provides the interface between each of the first and second application programs 152 and 154 and the BIOS.

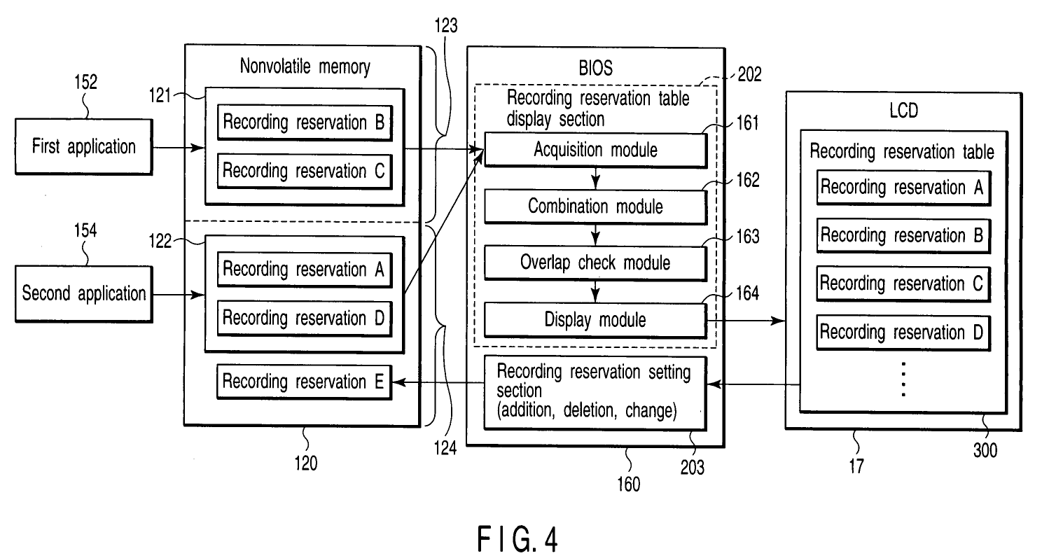

Next, a first example of the recording reservation table display process carried out by the recording reservation table display processing section 202 will be described with reference to FIG. 4.

The nonvolatile memory 120 has a storage area 123 and a storage area 124. The storage area 123 is accessible by the first application program 152, while the storage area 124 is accessible by the second application program 154.

The first application program 152 creates first recording reservation information (recording reservation B and recording reservation C) 121 as operated by the user and then retains the created information in the storage area 123 of the nonvolatile memory 120. The second application program 154 creates second recording reservation information (recording reservation A and recording reservation D) 122 as operated by the user and then retains the created information in the storage area 124.

When the recording reservation display button 15B is depressed by the user, the recording reservation table display processing section 202 integrates the first and second recording reservation information 121 and 122 stored in the memory 120 to create integrated recording reservation information. A recording reservation table 300 indicating a list of recording reservations contained in the integrated recording reservation information is then displayed on the screen of the LCD 17.

The recording reservation table display processing section 202 is composed of an acquisition module 161, a combination module 162, an overlap check module 163, and a display module 164. The acquisition module 161 acquires the first and second reservation information 121 and 122 from the storage areas 123 and 124, respectively, of the nonvolatile memory 120. The combination module 162 combines (integrates) the first and second recording reservation information 121 and 122 acquired by the acquisition module 161 to create the integrated recording reservation information. The overlap check module 163 checks the integrated recording reservation information for the presence of recording reservations which overlap in time and notifies the display module 164 of the results of this check. The display module 164 displays the table 300 of recording reservations on the LCD 17 on the basis of the integrated recording reservation information. In addition, the display module 164 has a function of displaying the results of the overlap check on the recording reservation table 300 on the basis of the notification from the overlap check module 163.

The user is allowed to perform operations to set new recording reservations on the recording reservation table 300. Also, the user is allowed to perform an operation to choose an application program (a program on which reservations are made) for carrying out recording corresponding to the new recording reservations on the recording reservation table 300. When the second application program is chosen as a program on which recording reservations are made, the recording reservation setting section 203 stores a new recording reservation as recording reservation E in the storage area 124 corresponding to the second application program.

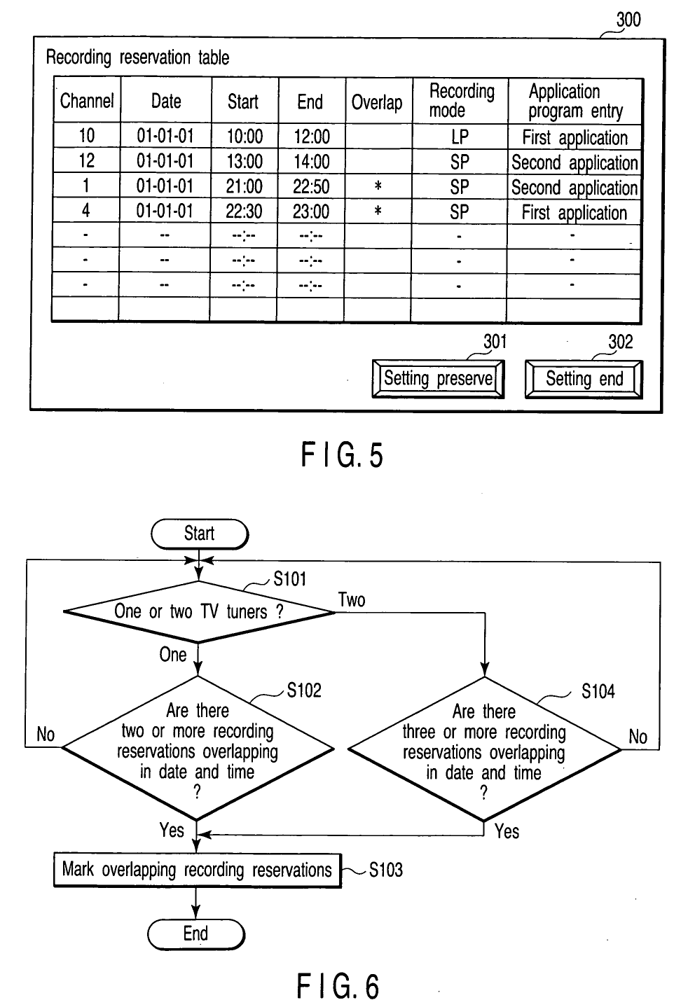

FIG. 5 shows an example of the recording reservation table 300.

In the recording reservation table 300, recording reservation condition information is displayed for each recording reservation, which includes entries of channel, date, recording start time, recording end time, overlap in time, recording mode, and application program entry are made. The channel entry indicates the number of a channel of a broadcast station over which broadcast program data is broadcast. The date entry indicates the date of recording. The recording start time entry indicates the time at which recording is to be started. The recording end time entry indicates the time of ending the recording. The overlap entry indicates that a recording reservation overlaps with another recording reservation in recording time defined by the date, recording start time and recording end time with a mark. The recording mode entry indicates the recording form of broadcast program data. The application program entry indicates the identifier of an application program which carries out recording.

On the recording reservation table 300 a setting preserve button 301 and a setting end button 302 are also displayed by means of the display module 164. When the setting preserve button 301 is operated by the user, the BIOS determines the contents of editing operations (addition and/or deletion of recording reservations, and change of recording reservation conditions) performed by the user on the table 300 and stores the contents of integrated recording reservation information subjected to the editing operations into the nonvolatile memory 120 through the use of the recording reservation setting section 203. The BIOS then terminates the display of the recording reservation table 300. On the other hand, when the setting end button 302 is operated by the user, the BIOS terminates the display of the recording reservation table 300 without storing the contents of integrated recording reservation information subjected to the editing operations into the nonvolatile memory 120.

Next, the overlap check processing carried out by the BIOS will be described with reference to a flowchart shown in FIG. 6.

The BIOS decides whether the number of TV tuners installed in the computer 10 is one or two (step S101). When one TV tuner is installed, that is, when the computer is equipped with the TV tuner 140 or the TV tuner 145, the BIOS decides whether or not two or more recording reservations which overlap in time are present in the integrated recording reservation information (step S102). In the presence of two or more recording reservations which overlap in time (YES in step S102), the BIOS displays a mark in the area in the column on overlap corresponding to each of the overlapping reservations (step S103).

When two TV tuners are installed, that is, when the computer is equipped with the TV tuner 140 and the TV tuner 145, the BIOS decides whether or not three or more overlapping recording reservations are present in the integrated recording reservation information (step S104). In the presence of three or more overlapping recording reservations (YES in step S104), the BIOS displays a mark in the area in the column on overlap corresponding to each of the overlapping reservations (step S103).

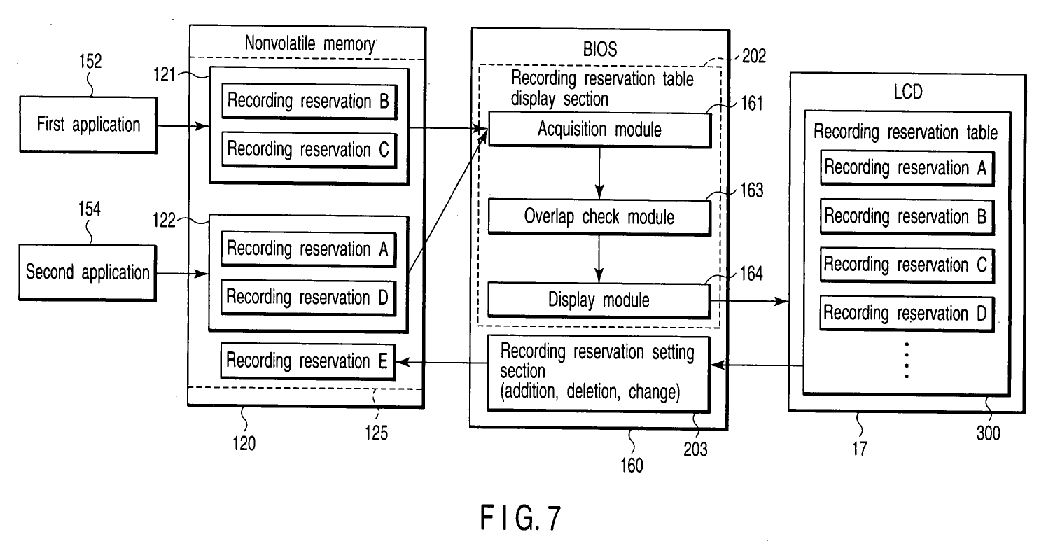

Next, a second example of the recording reservation table display processing will be described with reference to FIG. 7.

In the second example, the BIOS manages integrated recording reservation information using a shared storage area 125 accessible by each of the first and second application programs 152 and 154. That is, the shared storage area 125 is stored, as integrated recording reservation information, with the first recording reservation information 121 created by the first application program 152, the second recording reservation information 122 created by the second application program 154, and recording reservation information indicating the contents of recording reservations added by the recording reservation setting section 203.

The first application program 152 can handle not only the recording reservations B and C specified by the first recording reservation information 121 but also the recording reservations A and D specified by the second recording reservation information 122 and the recording reservation E added by the recording reservation setting section 203 as recording reservations on it. In a state where the first application program 152 has been booted up, therefore, it can execute recording processes corresponding to all the recording reservations contained in the integrated recording reservation information stored in the shared storage area 125.

Likewise, the second application program 154 can also handle not only the recording reservations A and D specified by the second recording reservation information 122 but also the recording reservations B and C specified by the first recording reservation information 121 and the recording reservation E added by the recording reservation setting section 203 as recording reservations on it. When the second application program 154 has been launched, therefore, it can execute recording processes corresponding to all the recording reservations contained in the integrated recording reservation information stored in the shared storage area 125.

The recording reservation table display processing section 202 is composed of the acquisition module 161, the overlap check module 163, and the display module 164. The acquisition module 161 acquires all the recording reservation information (the first and second reservation information 121 and 122 and the recording reservation information indicating the contents of recording reservations added by the recording reservation setting section 203) stored in the shared storage area 125 as integrated recording reservation information. The display module 164 displays the recording reservation table 300 indicating a list of recording reservations acquired by the acquisition module 161 on the screen of the LCD 17.

Each of the first and second application programs 152 and 154 can also display the recording reservation table by acquiring all the recording reservation information from the shared storage area 125.

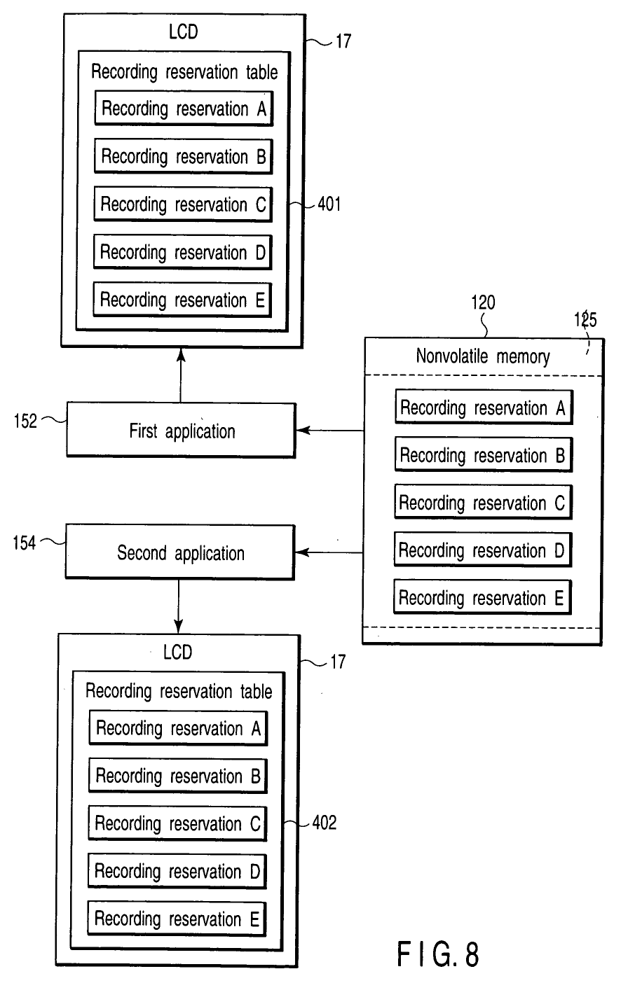

That is, as shown in FIG. 8, when a request is made by the user to display a table of recording reservations, the first application program 152 acquires integrated recording reservation information stored in the shared storage area 125 and then displays a recording reservation table 401 indicating a list of recording reservations contained in the acquired integrated recording reservation information on the screen of the LCD 17. Likewise, when a request is made by the user to display a table of recording reservations, the second application program 154 acquires integrated recording reservation information stored in the shared storage area 125 and then displays a recording reservation table 402 indicating a list of recording reservations contained in the acquired integrated recording reservation information on the LCD 17.

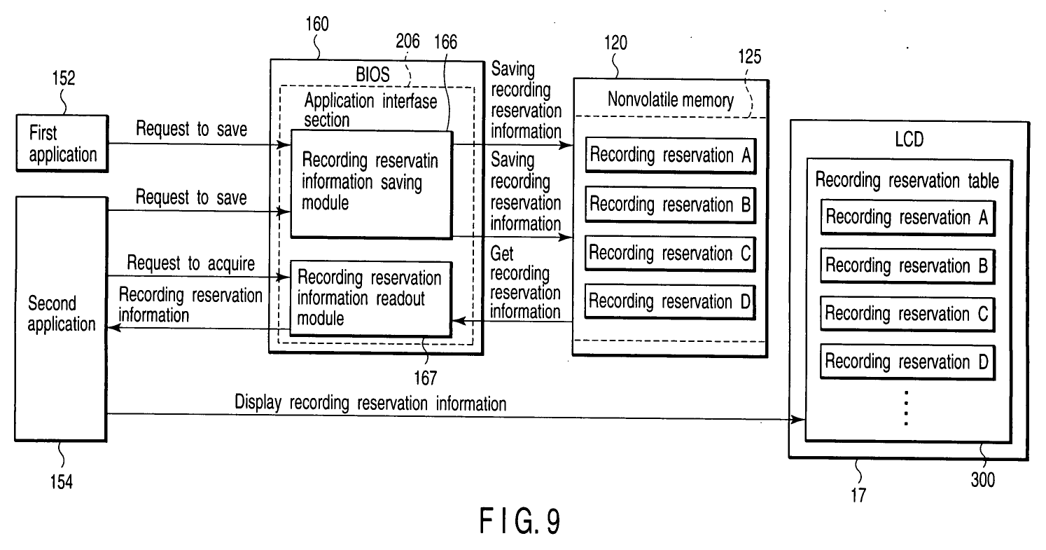

Next, the configuration of the application interface section 206 will be described with reference to FIG. 9.

In order to use the nonvolatile memory 120 as the shared storage area 125 accessible by each of the first and second application programs 152 and 154, the application interface section 206 is equipped with a recording reservation information preserving section 166 and a recording reservation information readout module 167.

The recording reservation information preserving section 166, upon receipt of a request to preserve recording reservation information from the first application program 152, write-accesses the shared storage area 125 and stores the first recording reservation information 121 created by the first application program into the shared storage area 125. Also, the recording reservation information preserving section 166, upon receipt of a request to preserve recording reservation information from the second application program 154, write-accesses the shared storage area 125 and stores the second recording reservation information 122 created by the second application program into the shared storage area 125.

Upon receipt of a recording reservation information acquisition request from the first application program 152, the recording reservation information readout module 167 read-accesses the shared storage area 125, then acquires all the recording reservation information stored in the shared storage area and passes all the information acquired to the first application program 152. Also, upon receipt of a recording reservation information acquisition request from the second application program 154, the recording reservation information readout module 167 read-accesses the shared storage area 125, then acquires all the recording reservation information stored in the shared storage area and passes all the information acquired to the second application program 154.

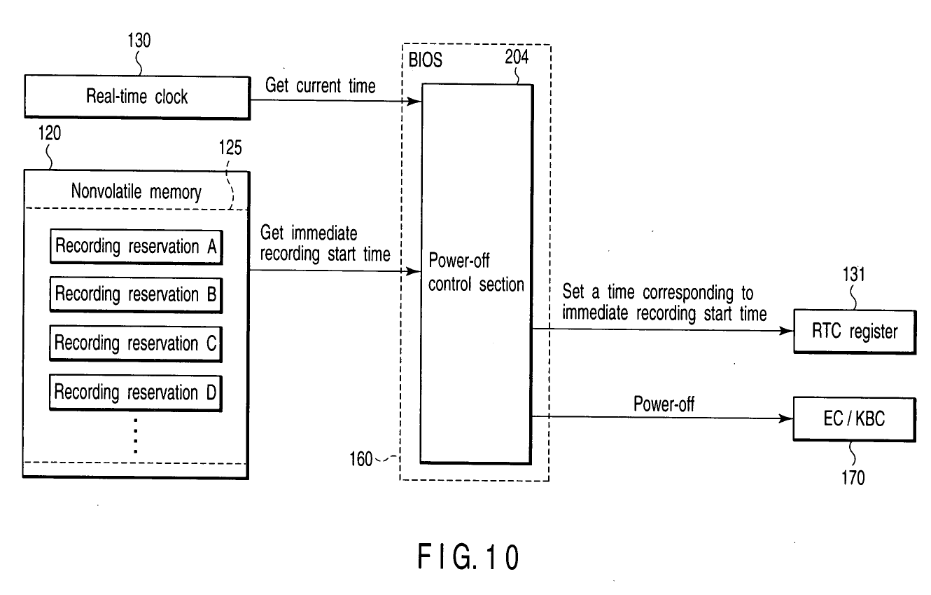

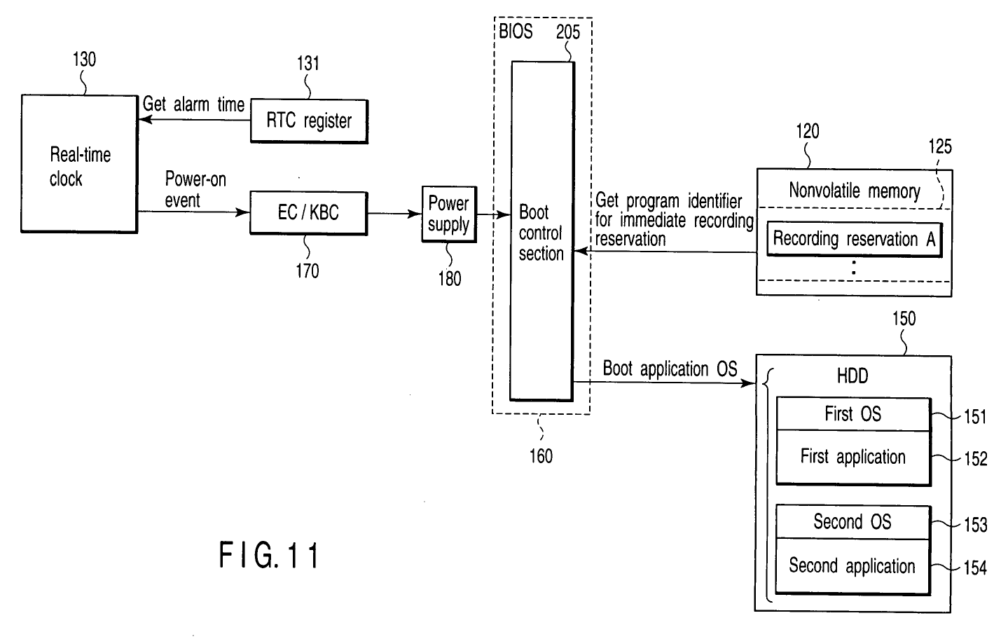

Next, a power-saving process carried out by the computer 10 will be described with reference to FIGS. 10 and 11.

In the power-saving process, a starting process and a power-off process are performed for each recording reservation in accordance with its recording start time and identifier. The starting process involves switching the computer 10 from the power-off state to the power-on state and launching one of the first and second application programs 152 and 154. The power-off process involves turning off the power to the computer 10 in response to the termination of recording carried out by the launched application program 152 or 154. The starting process and the power-off process are repeated for each recording reservation. The power-saving process is carried out by the power-off control section 204 and the boot control section 205.

FIG. 10 shows the power control operation carried out by the power-off control section 204.

For example, upon completion of recording for a certain recording reservation, the power-off control section 204 performs the power control operation. In this power control operation, the power-off control section 204 obtains the current time from the real-time clock 130 and then obtains the immediate recording reservation that specifies the recording start time nearest to the current time from the integrated recording reservation information. After that, the power-off control section 204 sets an alarm time to switch on the computer next time in the RTC register 131 on the basis of the recording start time specified by the acquired immediate recording reservation and then sends a power-off command to the EC/KBC 170 to turn off the power to the computer.

If the time difference between the current time and the recording start time of the immediate recording reservation is less than a predetermined period of time (e.g., five minutes), the power-off control section 204 maintains the computer 10 in the power-on state without setting the alarm time in the RTC register 131 and switching off to the computer. In this case, the recording for the immediate recording reservation is carried out by one of the first and second application programs 152 and 154 which has been launched.

FIG. 11 shows the starting operation performed by the boot control section 205.

When the alarm time set in the RTC register 131 is reached, the real-time clock 130 sends a power-on event to the EC/KBC 170, which upon detection of the occurrence of the power-on event turns on the power to the computer 10 in conjunction with the power supply circuit 180.

Thus, when the computer 10 is switched on in accordance with the alarm time, the boot control section 205 obtains the immediate recording reservation (reservation of the earliest recording start time) from the integrated recording reservation information stored in the shared storage area 125 and then launches one of the first and second application programs 152 and 154 on the basis of the program identifier corresponding to the immediate recording reservation.

If the program identifier indicates the first application program 152, then the boot control section 205 boots up the first operating system 151 and launches the first application program 152. Thereby, the recording for the immediate recording reservation is made by the first application program 152. If, on the other hand, the program identifier indicates the second application program 154, then the boot control section 205 boots up the second operating system 153 and launches the second application program 154. Thereby, the recording for the immediate recording reservation is made by the second application program 154.

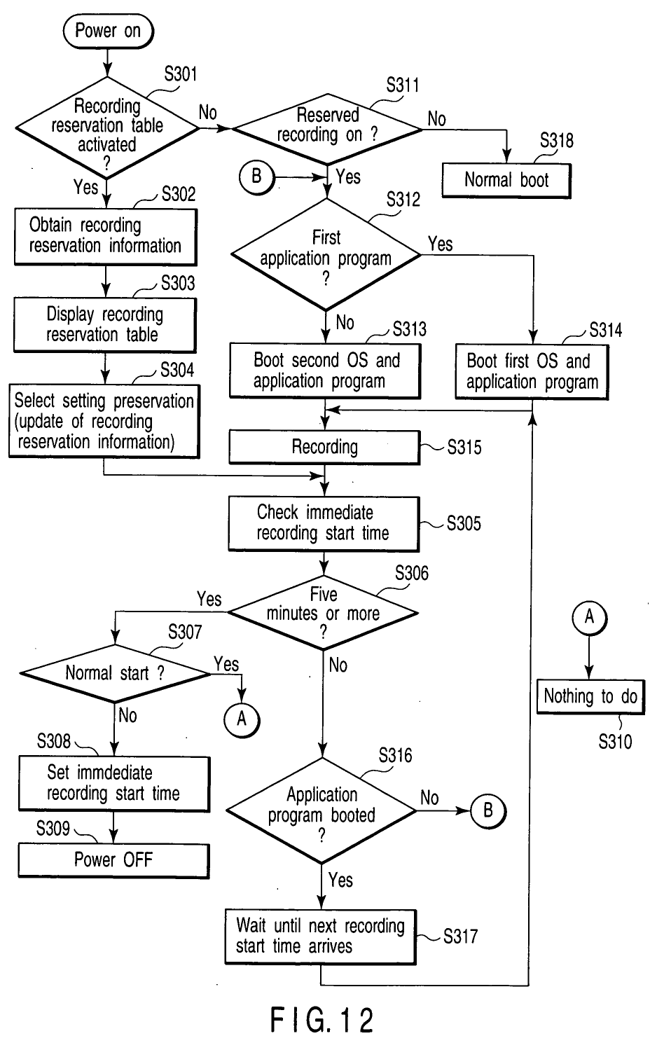

Reference is now made to a flowchart shown in FIG. 12 to describe a first example of a recording control operation performed by the computer 10.

It is assumed here that the integrated recording reservation information is preserved in the shared storage area 125 of the nonvolatile memory 120.

When the computer 10 is switched on, the BIOS performs a power-on cause identification process to identify the cause of the computer having been switched on (the power-on cause) (steps S301 and S311). In this process, the BIOS identifies the power-on cause from (1) the operation of the recording reservation display button 15B by the user (recording reservation table activation), (2) the arrival of the set alarm time (reserved recording ON), and (3) the operation of the power button 14 by the user (normal start).

If the power-on cause is the recording reservation table activation (YES in step S301), then the BIOS obtains the integrated recording reservation stored in the nonvolatile memory 120 (step S302) and then displays the recording reservation table 300 indicating a list of recording reservations contained in the integrated recording reservation information on the LCD 17 (step S303). When the setting preserve button 301 is operated on the recording reservation table display screen, the BIOS updates the integrated recording reservation information in accordance with the contents of edit operations performed on that display screen (step S304). Next, the BIOS checks the immediate recording start time (step S305). In step S305, the BIOS obtains the recording reservation that specifies the immediate recording start time nearest to the current time from the integrated recording reservation information stored in the nonvolatile memory 120. The BIOS then decides whether or not the difference between the current time and the immediate recording start time is less than a predetermined period of time (e.g., five minutes) (step S306).

If the difference time is not less than five minutes (YES in step S306), then the BIOS decides whether or not the cause of computer's power-on is normal boot (step S307). If so (YES in step S307), the BIOS performs a process of maintaining the computer 10 in the started state without switching off it (step S310). If the power-on cause is not the normal boot (NO in step S307), then the BIOS sets a time corresponding to the immediate recording start time (e.g., a time that is several minutes ahead of the immediate recording start time) in the RTC register 131 as an alarm time (step S308). The BIOS then sends a power-off command to switch off the computer 10 to the EC/KBC 170 to switch off the computer (step S309).

If, on the other hand, the difference time is less than five minutes (NO in step S306), then the BIOS decides whether or not one of the first and second application programs 152 and 154 has been already launched (step S316). If so (YES in step S316), the application program already launched waits for execution of recording until the time corresponding to the immediate recording start time arrives (step S317). When the time corresponding to the immediate recording start time is reached, the application program which has been launched carries out recording for the immediate recording reservation (step 315).

If, on the other hand, none of the application programs has been launched (NO in step S316), then the BIOS decides whether or not the program identifier for the immediate recording reservation indicates the first application program 152 (step S312).

If so, then the BIOS boots up the first operating system 151, and launches the first application program 152(step S314). If not, that is, if the program identifier indicates the second application program 154, then the BIOS boots up the second operating system 153, and launches the second application program 154 (step S313).

The launched application program, upon arrival of the time corresponding to the immediate recording start time, carries out recording for the immediate recording reservation (step S315). Upon termination of the recording, the BIOS performs the procedure beginning with step S305 again.

If the power-on cause is reserved recording ON (YES in step S311), then the BISO carries out the procedure beginning with step S312.

That is, the BIOS decides whether or not the program identifier corresponding to the immediate recording reservation in the column on program on which reservation is made (see FIG. 5) indicates the first application program 152 (step S312). If so, the BIOS boots up the first application program 152 as well as the first operating system 151 (step S314). If the program identifier indicates the second application program, then the BIOS starts the second application program 154 as well as the second operating system 153 (step S313). Upon the completion of recording by the started application program, the BIOS carries out the procedure beginning with step S305 again.

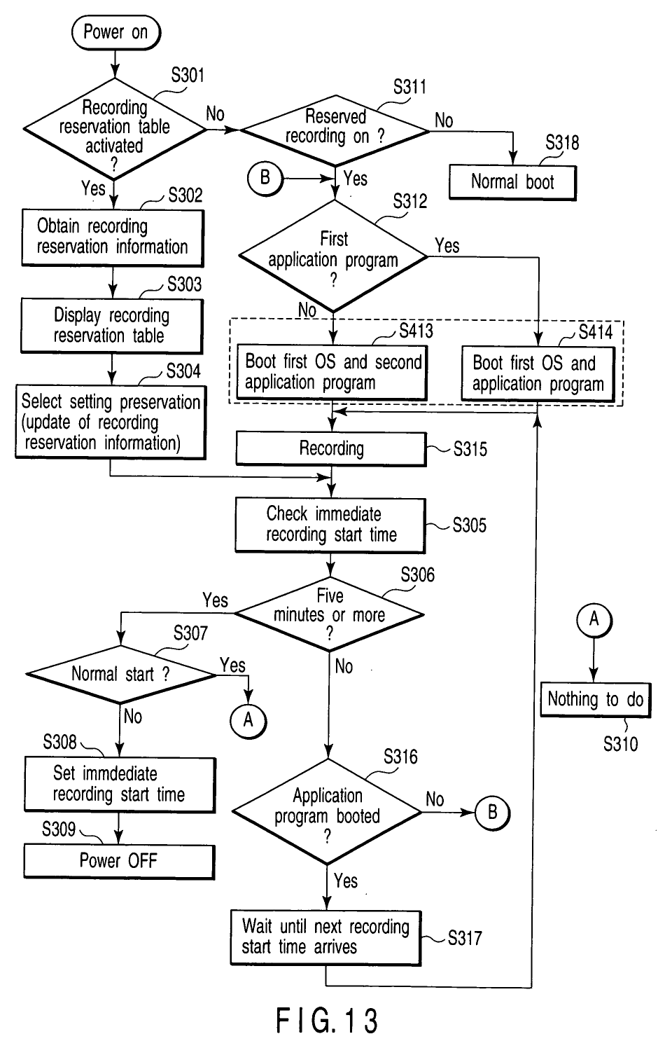

In this embodiment it is assumed that each of the first and second application programs 152 and 154 launches on a separate operating system; however, the first and second application programs may be configured to launch on the same operating system (for example, the first operating system 151). In such a case, steps S313 and S314 are replaced by steps S413 and S414 shown in a flowchart of FIG. 13.

In step S413, the BIOS starts the first operating system 151 and then the second application program 154. In step S414, the BIOS first starts the first operating system 151 and then the first application program 152.

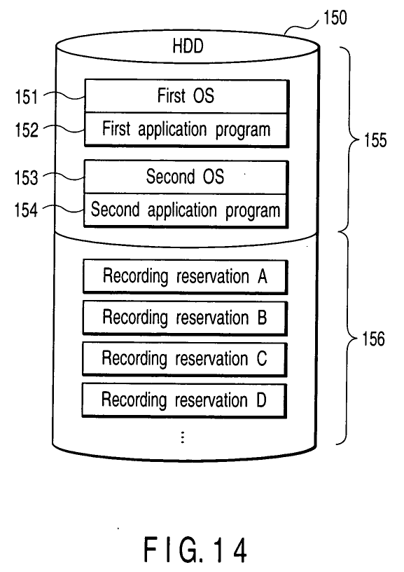

In addition, in this embodiment, the nonvolatile memory 120 is used as a shared storage area; however, a storage area 156 on the HDD 150 may be used as a shared storage area as shown in FIG. 14. In this case, the first operating system 151, the first application program 152, the second operating system 153 and the second application program 154 are stored in a storage area 155 on the HDD 150. When the recording reservation display button 15B is pressed by the user, the BIOS 160 displays the recording reservation table 300 indicating a list of recording reservations stored in the storage area 156 on the HDD 160 on the LCD 17. It is also possible to display the recording reservation table 300 on the LCD 17 when either of the first and second application programs 152 and 154 is operated by the user.

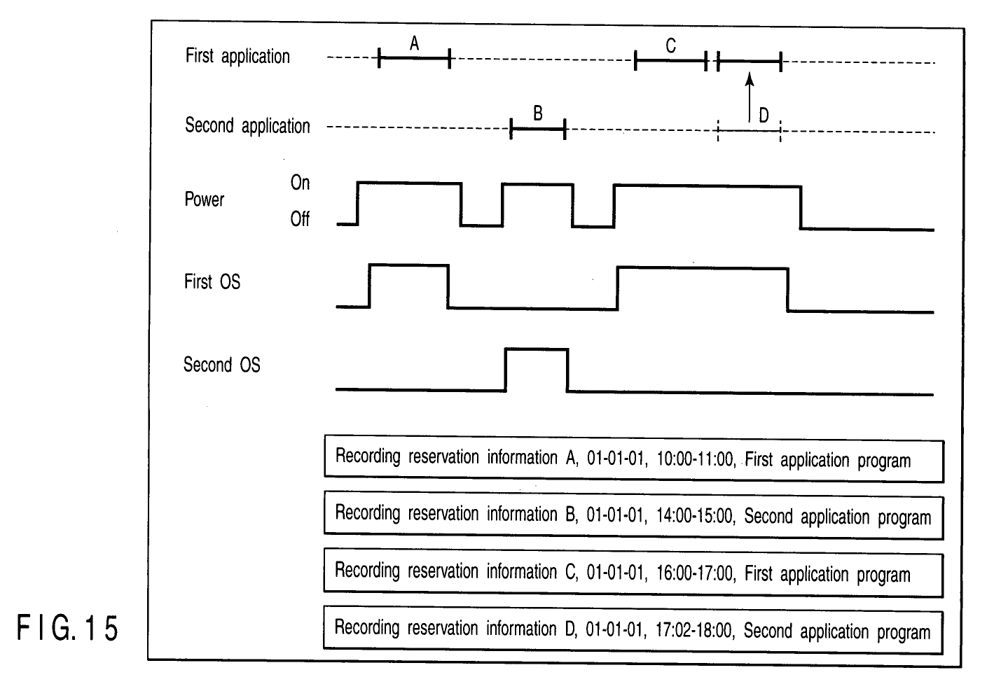

Next, the power saving operation performed by the computer 10 will be described with reference to a timing diagram shown in FIG. 15.

In this timing diagram there are illustrated the run times of the first and application program 152 and 154, the power-on/off times of the computer 10, and the run times of the first and second operating systems 151 and 153.

In FIG. 15, it is assumed that the recording reservations A through D are stored in the shared storage area 125. Suppose that an alarm time corresponding to the recording start time of the recording reservation A has been set in the RTC register 131.

Upon arrival of the alarm time, the computer 10 is automatically switched on. The BIOS starts the first operating system 151 and the first application program 152 in accordance with the program identifier corresponding to the recording reservation A. The first application program 152 is placed in the wait state until the recording start time of the recording reservation A is reached. Upon arrival of the recording start time, the first application program 152 carries out recording for the recording reservation A.

Upon completion of the recording for the recording reservation A, the BIOS confirms that it is a predetermined time (five minutes) or more before the recording start time of the next recording reservation B, then sets an alarm time corresponding to the recording start time of the recording reservation B in the RTC register 131 and turns off the power to the computer 10.

Upon arrival of the alarm time, the computer 10 is automatically switched on. The BIOS starts the second operating system 153 and the second application program 154 in accordance with the program identifier corresponding to the recording reservation B. The second application program 154 is placed in the wait state until the recording start time of the recording reservation B is reached. Upon arrival of the recording start time, the second application program 154 carries out recording for the recording reservation B.

Upon completion of the recording for the recording reservation B, the BIOS confirms that it is a predetermined time (five minutes) or more before the recording start time of the next recording reservation C, then sets an alarm time corresponding to the recording start time of the recording reservation C in the RTC register 131 and turns off the power to the computer 10.

Upon arrival of the alarm time, the computer 10 is automatically switched on. The BIOS starts the first operating system 151 and the first application program 152 in accordance with the program identifier corresponding to the recording reservation C. The first application program 152 is placed in the wait state until the recording start time of the recording reservation C is reached. Upon arrival of the recording start time, the first application program 152 carries out recording for the recording reservation C.

Upon completion of the recording for the recording reservation C, the BIOS maintains the computer 10 in the power-on state because it is less than five minutes before the recording start time of the next recording reservation D. The first application program 152 is placed in the wait state until the recording start time of the recording reservation D is reached. The program identifier corresponding to the recording reservation D indicates the second application program 154. However, the currently running program is the first application program 152 and the recording reservation D is stored in the shared storage area 125 accessible by the first application program 152 as well. Therefore, the second application program 154 handles the recording reservation D as a recording reservation on it and carries out recording for the recording reservation D.

As described above, according to the embodiment, the recording reservation information created by user operating the first application program 151 and the recording reservation information created by user operating the second application program 154 are integrated and the integrated recording reservation information containing all the recording reservations is managed by the BIOS. And the recording reservation table 300 indicating a list of all the recording reservations is displayed on the LCD 17. Therefore, the contents of recording reservations can be presented to the user in a batch, allowing the occurrence of malfunctions due to overlap in recording time to be prevented.

Moreover, the on-off control of the power to the computer 10 is performed on the basis of each of the recording reservations contained in the integrated recording reservation information, thus allowing recording for each of the recording reservations to be made automatically without causing more power consumption than is necessary.

Furthermore, since the integrated recording reservation information is managed using a shared storage area, each application program can carry out recording for a recording reservation created by the other application program. When little time is left before the recording start time specified by the immediate recording reservation, therefore, the recording for the immediate recording reservation can be made by an application program already started by simply maintaining the computer 10 in the power-on state.

Although the embodiment of the present invention has been described in terms of an application in which the recording reservation table 300 is displayed when the user depresses the recording reservation display button 15B, the table may be displayed by depressing a specific key on the keyboard 13 by way of example.

The recording control processing of this embodiment is wholly implemented by computer programs; therefore, simply installing these computer programs in a common computer through a computer-readable storage medium allows the same advantages as the present embodiment to be realized with ease.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus which executes first and second application programs each including a function of recording broadcast program data on the basis of recording reservations, comprising:
a receiver which receives broadcast program data in response to a request to receive broadcast program data from one of the first and second application programs; and
a recording management unit which integrates first recording reservation information indicating the contents of recording reservations and created by the first application program and second recording reservation information indicating the contents of recording reservations and created by the second application program, manages the integrated broadcast reservation information containing the first and second recording reservation information, and displays on a display unit a recording reservation table indicating a list of recording reservations contained in the integrated recording reservation information.

2. The information processing apparatus according to claim 1, wherein the recording management unit includes a display section which makes a decision as to whether or not recording reservations that overlap in reserved time are present in the integrated recording reservation information and displays the results of decision on the recording reservation table.

3. The information processing apparatus according to claim 1, wherein the integrated recording reservation information is stored in a shared storage area in the information processing apparatus which is accessible by each of the first and second application programs, and, when either of the first and second application programs has been started, it carries out recording for each of all the recording reservations in the integrated recording reservation information stored in the shared storage area.

4. The information processing apparatus according to claim 3, wherein the recording management unit includes a recording reservation adding/setting section which, in response to operations by a user on the recording reservation table, performs a process of adding new recording reservations to the integrated recording reservation information stored in the shared storage area and a process of changing the contents of arbitrary recording reservations in the integrated recording reservation information.

5. The information processing apparatus according to claim 3, wherein the recording management unit includes a preservation processing section which, in response to a request to retain recording reservation information from the first application program, stores the first recording reservation information in the shared storage area and, in response to a request to retain recording reservation information from the second application program, stores the second recording reservation information in the shared storage area and a pass section which, in response to a request to acquire recording reservation information from the first application program, passes the first and second recording reservation information stored in the shared storage area to the first application program and, in response to a request to acquire recording reservation information from the second application program, passes the first and second recording reservation information to the second application program.

6. The information processing apparatus according to claim 1, wherein the integrated recording reservation information contains an identifier that specifies one of the first and second application programs for each of the recording reservations contained in it, and the recording management unit repeatedly performs a starting process of changing the information processing apparatus from the power-off state to the power-on state and starting one of the first and second application programs in accordance with the recording start time and the identifier corresponding to each recording reservation contained in the integrated recording reservation information and a process of switching off the information processing apparatus upon termination of recording carried out by the started one of the first and second application programs.

7. The information processing apparatus according to claim 1, wherein the integrated recording reservation information contains an identifier that specifies one of the first and second application programs for each of the recording reservations contained in it, and the recording management unit includes a power-off control section which performs a power control process involving obtaining the immediate recording reservation that specifies the recording start time nearest to the current time from the recording reservations contained in the integrated recording reservation information, then setting an alarm time to switch on the information processing apparatus next time on the basis of the recording start time specified by the immediate recording reservation obtained and switching off the information processing apparatus and a boot control section which performs a start process involving starting one of the first and second application programs on the basis of the identifier corresponding to the immediate recording reservation when the information processing apparatus is switched on in accordance with the set alarm time.

8. The information processing apparatus according to claim 7, wherein the first application program is configured to run on a first operating system and the second application program is configured to run on a second operating system, and the boot control section starts the first operating system and the first application programs when the identifier corresponding to the immediate recording reservation specifies the first application program and starts the second operating system and the second application programs when the identifier corresponding to the immediate recording reservation specifies the second application program.

9. The information processing apparatus according to claim 7, wherein the power-off control section performs the power control process with each termination of recording for the immediate recording reservation made by one of the first and second application programs started by the boot control section.

10. The information processing apparatus according to claim 1, wherein the integrated recording reservation information is stored in a shared stored area in the information processing apparatus which is accessible by each of the first and second application programs and each of the first and second applications is configured to, when it has been started, make recording for each of the recording reservations in the integrated recording reservation information stored in the shared storage area, and the integrated recording reservation information contains an identifier that specifies one of the first and second application programs for each recording reservation contained in the integrated recording reservation information, and wherein the recording management unit includes a power-off control section which performs a power control process involving obtaining the immediate recording reservation that specifies the recording start time nearest to the current time from the recording reservations contained in the integrated recording reservation information, making a decision as to whether or not the time difference between the current time and the recording start time specified by the obtained immediate recording reservation is less than a predetermined time, when the time difference is not less than the predetermined time switching off the information processing apparatus after an alarm time to switch on the information processing apparatus next time has been set on the basis of the recording start time specified by the obtained immediate recording reservation, and maintaining the information processing apparatus in the power-on state when the time difference is less than the predetermined time so that recording for the immediate recording reservation is made by one of the first and second application programs which is been currently started, and a boot control section which performs a start process involving starting one of the first and second application programs on the basis of the identifier corresponding to the immediate recording reservation when the information processing apparatus is switched on in accordance with the set alarm time.

11. For use with an information processing apparatus which executes first and second application programs each having a function of recording broadcast program data on the basis of recording reservations, a recording control method comprising:
integrating first recording reservation information indicating the contents of recording reservations and created by the first application program and second recording reservation information indicating the contents of recording reservations and created by the second application program;
managing the integrated broadcast reservation information containing the first and second recording reservation information; and
displaying on a display unit a recording reservation table indicating a list of recording reservations contained in the integrated recording reservation information.

12. The recording control method according to claim 11, further comprising making a decision as to whether or not recording reservations that overlap in reserved time are present in the integrated recording reservation information and displaying the results of decision on the recording reservation table.

13. The recording control method according to claim 11, wherein the integrated recording reservation information is stored in a shared storage area in the information processing apparatus which is accessible by each of the first and second application programs, and, when either of the first and second application programs has been started, it carries out recording for each of all the recording reservations in the integrated recording reservation information stored in the shared storage area.

14. The recording control method according to claim 13, further comprising performing a recording reservation adding/setting process which involves adding new recording reservations to the integrated recording reservation information stored in the shared storage area and changing the contents of arbitrary recording reservations in the integrated recording reservation information in response to operations by a user on the recording reservation table.

15. The recording control method according to claim 11, wherein the integrated recording reservation information contains an identifier that specifies one of the first and second application programs for each of the recording reservations contained in it, and further comprising repeatedly performing a starting process involving changing the information processing apparatus from the power-off state to the power-on state and starting one of the first and second application programs in accordance with the recording start time and the identifier corresponding to each recording reservation contained in the integrated recording reservation information and a power-off process involving switching off the information processing apparatus upon termination of recording carried out by the started one of the first and second application programs.

16. The recording control method according to claim 11, wherein the integrated recording reservation information contains an identifier that specifies one of the first and second application programs for each of the recording reservations contained in it, and further comprising performing a power control process involving obtaining the immediate recording reservation that specifies the recording start time nearest to the current time from the recording reservations contained in the integrated recording reservation information, then setting an alarm time to switch on the information processing apparatus next time on the basis of the recording start time specified by the immediate recording reservation obtained, and switching off the information processing apparatus and performing a start process involving starting one of the first and second application programs on the basis of the identifier corresponding to the immediate recording reservation when the information processing apparatus is switched on in accordance with the set alarm time.

17. The recording control method according to claim 11, wherein the integrated recording reservation information is stored in a shared stored area in the information processing apparatus which is accessible by each of the first and second application programs and each of the first and second applications is configured to, when it has been started, make recording for each of the recording reservations in the integrated recording reservation information stored in the shared storage area, and the integrated recording reservation information contains an identifier that specifies one of the first and second application programs for each recording reservation contained in the integrated recording reservation information, and further comprising performing a power control process which involves obtaining the immediate recording reservation that specifies the recording start time nearest to the current time from the recording reservations contained in the integrated recording reservation information, making a decision as to whether or not the time difference between the current time and the recording start time specified by the obtained immediate recording reservation is less than a predetermined time, when the time difference is not less than the predetermined time switching off the information processing apparatus after an alarm time to switch on the information processing apparatus next time has been set on the basis of the recording start time specified by the obtained immediate recording reservation, and maintaining the information processing apparatus in the power-on state when the time difference is less than the predetermined time so that recording for the immediate recording reservation is made by one of the first and second application programs which is being currently started, and performing a start process involving starting one of the first and second application programs on the basis of the identifier corresponding to the immediate recording reservation when the information processing apparatus is switched on in accordance with the set alarm time.
